(19) United States
(12) Patent Application Publication
(10) Pub. No.: US 2017/0352086 A1
(43) Pub. Date: Dec. 7, 2017

(54) METHOD AND SYSTEM FOR AN INTELLIGENT MOBILE DEVICE TRIGGERED TERMINAL

(71) Applicants: VARUN SHARMA, San Francisco, CA (US); AJIT VILASRAO PATIL, San Francisco, CA (US); AVIRAL AGARWAL, San Francisco, CA (US)

(72) Inventors: VARUN SHARMA, San Francisco, CA (US); AJIT VILASRAO PATIL, San Francisco, CA (US); AVIRAL AGARWAL, San Francisco, CA (US)

(21) Appl. No.: 15/175,411

(22) Filed: Jun. 7, 2016

(51) Int. Cl. G06Q 30/06; H04L 29/08; H04W 8/18

(52) U.S. Cl. CPC G06Q 30/0631; H04W 8/183; H04L 67/306; H04L 67/34

(57) ABSTRACT

A system is disclosed that incorporates mobile devices (such as mobile phones or smart watches), a user profile stored in the cloud, and a triggered device (e.g., point-of-sale terminals or ATM terminals) such that the mobile devices communicate user interactivity information to the triggered device, and the triggered device provides transactional predictions, recommendations, and preferences to the user to interact before making purchases on the triggered device.

### FIELD OF INVENTION

This invention generally relates to a system of devices, including point-of-sale devices, mobile devices of users, and cloud storage of user profiles, that provide intelligence to purchasing recommendations.

### BACKGROUND

A key area in retail markets is to understand the customer in terms of spending patterns, preferences and inferred attributes. Several solutions exist in the market providing limited functionality to understand the customer. One of the shortfalls is terminals at merchants or devices such as ATMs have not been updated to participate in the spending patterns and recommendations. In addition, due to the popularity of cloud storage, many solutions rely on the cloud infrastructure as an intermediary and do not provide a direct communication between the devices.

### SUMMARY

Aspects of the invention include methods and systems to create a data packet structure that is transmitted directly between two devices (e.g., user's mobile device and POS or ATM terminal) without the need to have a cloud or remote storage or server as an intermediary. In one embodiment, a system may first create a customer profile for a customer in a remote server or in a remote distributed computing environment, such as cloud storage and cloud processing. In this fashion, the customer profile may include at least purchase history, purchase preferences, and purchase habits, etc., of the customer. In one embodiment, the customer profile may be encrypted. Once the customer profile has been established, the embodiments of the invention may further install a copy or version of the customer profile on a mobile device of the customer. This version of the profile may be regularly synchronized with the version of the profile in the cloud storage such that both versions are current.

Once the version of the profile is instantiated on the mobile device of the customer, aspects of the invention may collect and monitor data based on the customer's interactive activities, such as purchasing habits, patterns, preferences, etc., on the mobile device. In one embodiment, the version of the profile stored on the mobile device may be stored in a secured portion of the device or in a secured manner through encryption, etc. For example, aspects of the invention may install cookies or other tracking notes or mechanisms, of course being mindful about customer's privacy issues, to accomplish this collection of data. In one embodiment, profile data collection or updates may be triggered by interactional events, including browsing events, intent to purchase events, actual transaction or purchase events, linked social media activity events (e.g., sharing of products), etc. In another embodiment, the customer may also review the collected data in the profile. In a further embodiment, the user may further modify or change the presentation or organization of the data, such as according to a timeline or deciding to remove or keep them. Embodiments of the invention may further analyze the collected data stored as part of the profile.

As the data continues to build in the profile, the system according to aspects of the invention may also enable the mobile device to communicate directly with the terminals, such as point-of-sale (POS), kiosk, or ATM terminals, to further pass the profile data from the version stored in the mobile device along such that the terminals may intelligently provide additional purchasing incentives, recommendations, suggestions, or purchase offers to the customers upon using the terminals. For examples, the data may be presented or converted to a data packet structured according to embodiments of the invention as an exemplary metadata matrix that will be packaged for transmission via wireless networking protocols, such as Bluetooth, RFID, NFC, etc. to the POS or ATM terminals.

Upon receiving such packaged data in the terminals, which may be triggered by the mobile device, the terminals may provide intelligent offers or potential purchasing incentives to the customer near or at the terminals.

### BRIEF DESCRIPTION OF THE DRAWINGS

The invention may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIG. 1 illustrates an overview of a system of an intelligent mobile device triggered terminal according to one embodiment of the invention;

FIG. 2 illustrates a diagram of interactions of a user profile on a mobile device of a user according to one embodiment of the invention;

FIG. 3 illustrates a diagram of interactions between a mobile device, a cloud server, and one or more triggered devices according to one embodiment of the invention;

FIG. 4 illustrates a diagram of exemplary data structure of a user profile according to one embodiment of the invention;

FIG. 5 illustrates a flow chart of a method of an intelligent mobile device triggered terminal according to one embodiment of the invention;

FIG. 6 is an illustration of a portable computing device suitable for aspects of the invention; and

FIG. 7 is an illustration of a server computing device suitable for aspects of the invention.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

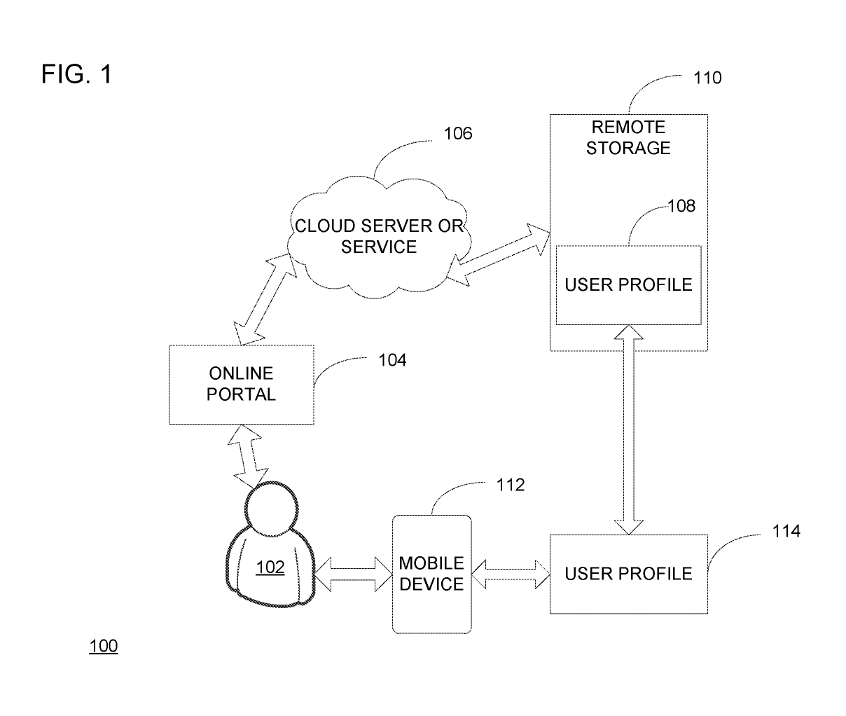

Referring now to FIG. 1, an overview of a system of an intelligent mobile device triggered terminal according to one embodiment of the invention may be illustrated. In one embodiment, a system 100 may include one cloud server or service 106 connected or coupled to an online portal 104 and a remote storage unit 110. In one embodiment, the system 100 may include a cluster of cloud servers or services 106 that may not be limited to one physical location but are connected in distributed network sense. In another embodiment, the cloud server or services are connected via the

Internet or other kinds of computer networks.

The cloud server or service 106 may be in constant network communications and connections with the online portal 104 and the remote storage unit 110. According to aspects of the invention, a user 102 may wish to enjoy a service of seamless connectivity between devices in his purchasing routine across different devices. Many approaches have been proposed but the approaches may center around providing a universal experience using a central depository of information and pushing the information to different devices. However, the central depository approach may generate delay and redundancy when information source is created from individual devices.

Embodiments of the invention may propose an approach by providing a device triggered approach, such as using a mobile device 112. Aspects of the invention may enable the user 102 to visit the online portal 104 to register (e.g., creating a login using a variety of mechanisms) and create a user profile 108. This approach at least improves the functionality of the mobile device, the triggered device, etc., because the data involved is substantially and immediately available from the mobile device or the triggered device. The need to retrieve information from remote cloud server for the same data is lessened. This may create a better and richer experience for the user.

In one embodiment, the user 102 may visit the online portal 104 via the mobile device 112 or any other device that is capable of displaying or providing information of the online portal 104 to the user 102. For example, the user 102 may use his or her own home desktop or laptop, work desktop or laptop, etc., to visit the online portal 104. In one example, the mobile device 112 includes a cellular phone, a smartphone, a smart watch, a smart wristband, a pair of “smart” glasses, a tablet, etc. In another example, the mobile device 112 may not need to be mobile as the device could also be one's computer that does not typically move, relative to a mobile phone or a smartphone. This user profile 108 may include a data structure storing user transaction information. For example, the data structure of the user profile 108 may include information or data such as credit card information, contact information (e.g., phone number, addresses, email addresses, date of birth, name, etc.), loyalty program information, affiliated program information, preferred program status information, purchase history, purchase preferences, and purchase habits, etc. In addition, the data structure of the user profile 108 may store information such as mobile device information as well as session information (to be further discussed below). As such, the user profile 108 may be considered as a “virtual card” for the user. It is to be understood that other transactional information may be included without departing from the spirit and the scope of the invention. As such, the data structure of the user profile 108 may include and define data fields for storing the information or data described above.

Once the user 102 created the user profile 108, the cloud server or service 106 may store a copy of the user profile 108 on the remote storage unit 110. Next, the user 102 may be directed to download an app or a program to the mobile device. In response to the download, the user 102 may log into the app using credentials created when the user 102 first creates the user profile 108 via the online portal 104. The user 102 may create a user profile 114, which may include the similar data structure as the user profile 108 with the defined data fields. In fact, the user profile 108 and the user profile 114 may frequently synchronize the information stored such as to update the data structure or profile executable instructions. In another embodiment, the synchronization may synchronize the user profile 108 partially, depending on the changes or differences between the last synchronization. In one example, the user profile 114 may include session information related to the mobile device 112. In one embodiment, the user 102 may not need to download an app or a program to create the user profile 114. In this example, the user profile 114 may be independently stored or created based on the operating system of the mobile device 112. For example, Microsoft Windows, Apple iOS operating system, Android mobile operating system, etc., may allow group policies or profiles to be stored and used without an additional app downloaded. For example, the user 102 may visit the online portal 104 and upon authenticating the credentials, the online portal 104 may push the user profile 114 to be instantiated on the mobile device 112.

Embodiments of the invention may enable the user profile 114 to collect and store additional information about the user 102 on the mobile device 112. For example, the user profile 114 may include executable instructions or codes to activate or energize different pieces of the hardware of the mobile device or different apps or pieces of software of the mobile device 112. As another example, the user profile 114 may enable codes, configured for execution by a processor of the mobile device 112, to monitor or track online activities of the user 102. In yet another example, the executable instructions or codes may enable the processor of the mobile device 112 to read cookies or other log files stored on the mobile device 112 to identify the interaction information. The interaction information may include, but not limited to, browsing activities, social networking activities, browsing content activities, etc. Additionally, the user profile 114 may receive information from different pieces of hardware of the mobile device 112, such as the GPS sensor, cellular signal sensor, heart rate monitor sensor, Bluetooth sensor, NFC sensor, etc. In the example where the mobile device 112 is a smart watch, the data structure of the user profile 114 may further include optional data fields for storing notifications sent and received between the smart watch and the smartphone or another mobile device that is coupled or connected therewith. As such, the user profile 114 may be in some circumstances be loaded as a bootloader payload for the processor of the mobile device 112 to execute.

In either instance, the executable codes or instructions to be executed by the processor of the mobile device may analyze the activities of the user 102 and store information in the data structure of the user profile 114 of the user 102 to identify a set of transactional behaviors or patterns of the user 102. During this process, the user profile 114 may periodically synchronize with the user profile 108. Additionally, as described above, the user profile 114 may include data fields for storing the session information of the mobile device 112. In one example, the session information may include time information and the state information of activities of the mobile device 112. As an illustration and not as a limitation, the session information may include one or more web pages the user 102 is viewing or has viewed, one or more of apps opened in the mobile device 112, time the user 102 spends on viewing the one or more web pages, content of the one or more web pages, etc.

As such, embodiments of the invention may build or construct a data-rich user profile 114 to enable the mobile device 112 to use when the mobile device 112 triggers other devices in an interactive fashion.

It is also understandable that the privacy of the user 102 may be important. As such, in one embodiment, the user 102 may review the user profile 114 to determine whether certain information or data should be stored or monitored. Embodiments of the invention may provide the user profile 114 in a user-friendly rendering or format such that the user 102 could use gesture-like control or graphical user interface (GUI) to configure, modify, or review the information in the user profile 114. This approach of embodiments of the invention overrides the routine and conventional sequence of events as other approaches frequent hide the information and use the cloud storage to shield direct access by the user. In another embodiment, the user 102 may also determine how often the user profile 114 synchronize with the user profile 108.

It is also understood that the mobile device 112 may include limited storage space for storing the user profile 114 and other data or information, such as apps or the operating system of the mobile device 112. Therefore, the user profile 114 may include options, settings or configurations to enable the user 102 to decide how much information is stored on the mobile device 112. In an example, the user profile 114 may, after collecting the information or data in temporary storage, synchronize with the user profile 108 before removing the information or data to save memory storage of the mobile device 112.

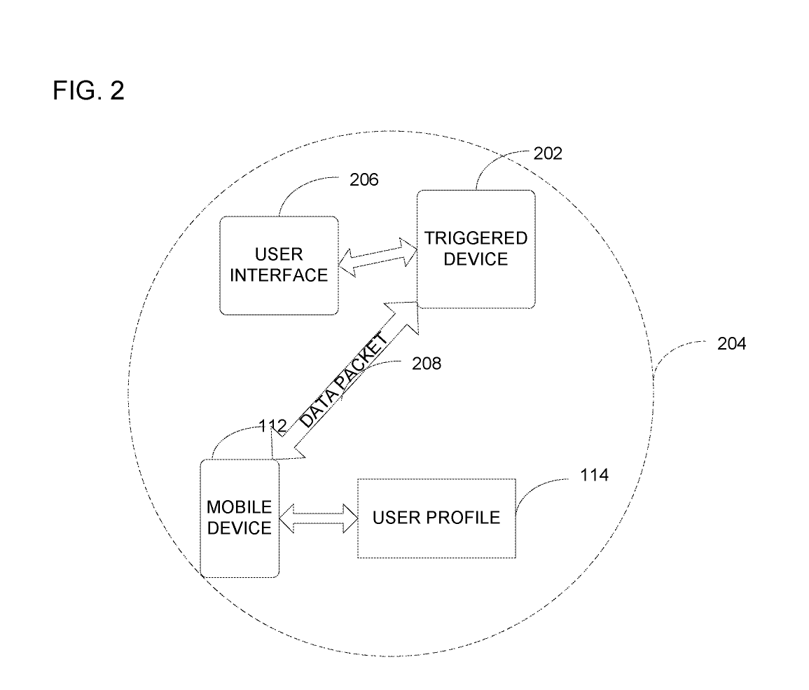

Referring now to FIG. 2, a diagram may illustrate interactions between a user profile on a mobile device of a user and a triggered or target device according to one embodiment of the invention. As described above, the user profile 114 may be stored and instantiated on the mobile device 112 and may gather and collect transactional information of the user 102 based on the interaction activities of the user 102 on the mobile device 112. The following example further illustrates, not as a limitation, aspects of the invention that may be part of triggering interactions between the mobile device 112 and a triggered device 202. These triggering interactions also may cause the user profile 114 to be updated, but not necessarily synchronized with the cloud server 106. In one embodiment, the synchronization of the user profile 114 and user profile 108 and the update of the user profile 114 by a triggering interaction may be simultaneous in response to a specific triggering interaction. For example, a specific and explicit user instruction or an account reset may just be a small set of example of such triggering interaction.

Suppose the user 102 interacts with the mobile device 112 while commuting to work. The interactions may include browsing news stories, reviewing email messages and updating the social network pages of the user 102. One of the interactions may include a series of messages received from a family member of the user 102 regarding a purchase of a certain item. In response to the series of messages, the user 102 may start searching for and surfing the Internet for identifying deals or sales as an indication or a desire to purchase the item. Around the same time, the user 102 may have exited the public transportation system to go to a nearby ATM terminal. These action may be recorded or collected in the user profile 114 through the GPS sensor or chip and/or cellular data usage along with looking up nearby locations of ATM terminals by the user 102 on a browser or a search engine.

As indicated above, the user profile 114 may include information such as the session information of the interactive activities of the user 102. As such, a session associated with the search for the item may be stored in the user profile 114. Another session for the ATM locations on the search engine may be stored in the user profile 114 as well.

In one embodiment, the triggered device 202 may be the ATM terminal. Using the example above, the user 102 may approach the triggered device 202 to retrieve cash, check balances, fund transfer, bill pay, or any other transactions that are offered by the triggered device 202. According to embodiments of the invention, the triggered device 202 and the mobile device 112 may both include connectivity hardware devices that enable wireless connections. In this example, the mobile device 112 and the triggered device 202 may include wireless chips or pieces of hardware that are capable of communicating with another device or each other based on wireless networking protocols, such as Bluetooth, RFID, NFC, etc. These wireless networking protocols may incorporate aspects of geofensing and proximity locational information based on signal strength transmitted or received to or from the devices. As such, using the example of the user 102 of approaching the ATM terminal, as the user 102 approaches the triggered device 202, the approach may be treated as a triggering event. As such, the wireless hardware within the mobile device 112 may be attempting to communicate with the triggered device 202 once the mobile device 112 and the triggered device 202 are within a zone of connectivity 204. It is to be understood that the zone of connectivity 204 shown in FIG. 2 may be a simplified illustration, and not a limitation, of the reach of the signals of the wireless devices.

Based on the specifications of the particular wireless networking protocols, the mobile device 112 and the triggered device 202 may negotiate a connection. The mobile device 112 may display a message, vibrate in a specific pattern, produce audio alerts, or a combination of the above or other techniques to inform or alert the user 102 that the mobile device 112 is attempting to connect with the triggered device 202. In one embodiment, a user interface (UI) 206 may be coupled to the triggered device 202 that also displays a message or plays an audio message to inform the user that the mobile device 112 wishes to establish a connection. The user 102 may be given an opportunity to confirm or deny the connection. In one embodiment, as part of protecting the privacy of the user 102, a lack of response to either of the alerts on the mobile device 112 or the triggered device 202 may be interpreted as a denial of the connection.

In the event that the user 102 confirms the connection, the mobile device 112 may access the user profile 114 and send a data packet 208 to the triggered device 202 in response to the confirmed connection. In this example, due to the fact that the triggered device 202 is an ATM terminal, the data packet 208 transmitted to the triggered device 202 may include information relating to the interactive activities of attempting to purchase the item as well as the session information. The triggered device 202, which also may include a processor and a memory storage, may receive this data packet 208 and the processor may execute instructions to process the data packet 208. In one embodiment, the data packet 208 may include bootloader instructions such that the processor of the triggered device 202 may execute the instructions in addition to the system or the software of the triggered device 202. For example, the data packet 208 may be received as a payload for the execution by the processor such that the upon further verification, the processor of the triggered device 202 may provide UI for the user 102 to interact therewith.

Upon receiving the data packet 208, the triggered device 202 may process the data and information contained in the data packet 208. In response to processing, the triggered device 202 may provide information to the UI 206 to the user 102 for further interaction.

Using the example described above regarding the user who was searching or surfing the Internet for an item before heading to an ATM terminal, the data packet 208 from the mobile device 112 of the user 102 may be transmitted to the eligible or compatible ATM terminal (i.e., a triggered device 202 having compatible hardware parts). The ATM terminal, upon processing the data packet 208, may still prompt the user 102 to operate the ATM terminal, such as inserting a debit card or a credit card of the user 102 to the ATM terminal before entering PIN codes of the corresponding debit card or the credit card. Upon a successful authentication, the ATM terminal, in addition to displaying or rendering the standard operational menu options (such as withdrawal, deposit, check balances, etc.), may display or render data based on the data packet 208. That is, the ATM terminal may display or render a set of continuity information such as:

(a) “If you wish to purchase the item you were looking for, you may wish to withdraw an additional amount of ______.” Or

(b) “Good news, you will receive a promotional discount for purchasing the item you were looking for by using your debit card! Please click here for more information.” Or

(c) “Great news, you may redeem reward points in your checking account for purchasing the item you were looking for at this store ______ using your debit card.” Or

(d) “Buy the item at the online store of ______ using your debit card and receive a 10% discount!”

Embodiments of the invention may enable the ATM terminal to provide the set of continuity information as a function of the data packet 208 that is processed, such as the session information and the browsing history therein to give a “connected” experience to the user 102. The continuity information provided by the triggered device 202 or the ATM terminal may be more than the raw data provided from the data packet 208. In the example above, the continuity information may include recommendations or suggestions based on the information in the data packet 208.

In another embodiment, the ATM terminal or another triggered device 202 may, in composing the continuity information, supplement the processing of the data packet 208 by connecting to the Internet separately. In this example, the ATM terminal may additionally search information based on the data or information from the data packet 208. For instance, the ATM terminal may retrieve product ratings or pricing comparison information on the UI 206 for the user 102 to review or consider as part of the continuity information. In another embodiment, the ATM terminal may retrieve information or the latest offerings of a loyalty program if the data packet 208 includes the user's information of the loyalty program.

In another example, the user 102 may not be visiting the ATM terminal but a store with one or more cash register or Point-of-Sale (POS) terminals. In this example, for those cash register terminals having compatible hardware parts, the mobile device 112 of the user 102 may interact therewith in a similar fashion as the ATM terminal example above. In other words, in response to the mobile device 112 of the user 102 being in a range of connectivity, the mobile device 112 and the POS terminal may exchange the data packet 208 to provide the set of continuity information as a rich experience for the user 102. This experience is similar to having a halo or a field of connectivity centered around the mobile device 112 of the user 102. It may be dynamic and constantly refreshed due to the user's activities and interactions on the mobile device 112. Unlike previous approaches of waiting for the remote server to push the information to the different devices, aspects of the invention may enable the mobile device 112 to push the data packet 208 to the relevant triggered devices 202 in response to the user's activities and the different triggering events.

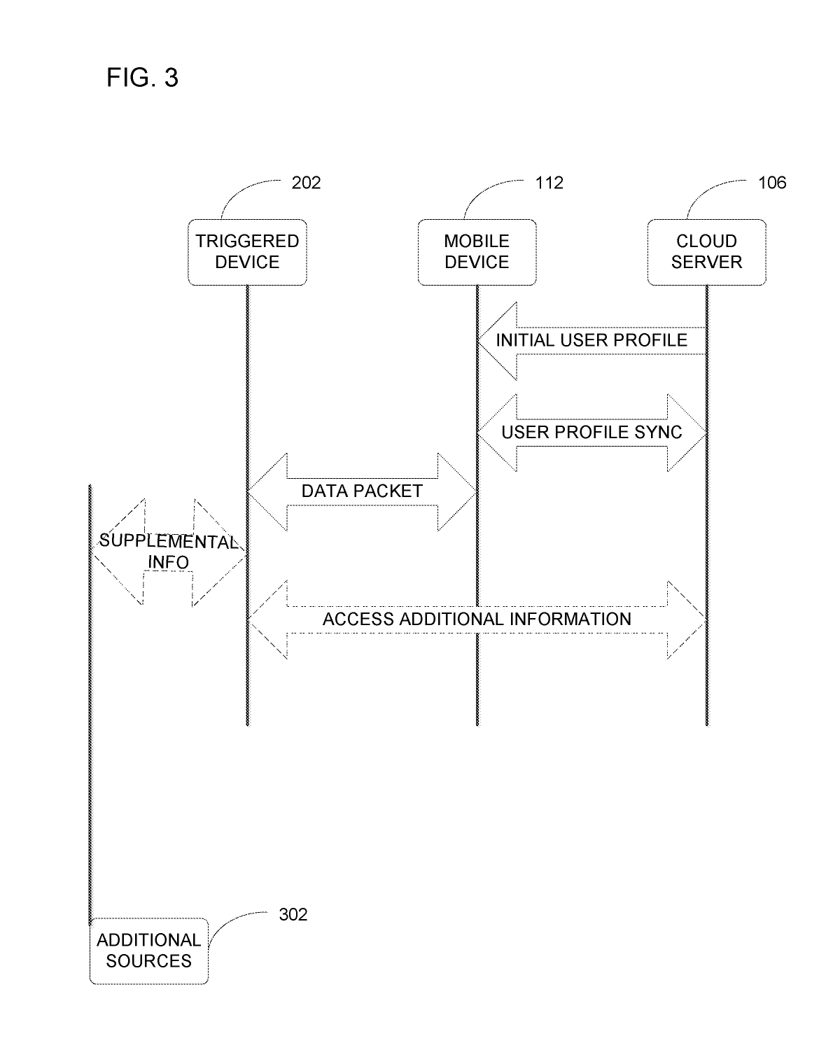

FIG. 3 may illustrate a diagram of interactions between a mobile device, a cloud server, and one or more triggered or target devices according to one embodiment of the invention. For example, FIG. 3 may illustrate an exemplary data flow diagram showing data flow among the mobile device 112, the cloud server or services 106, and the triggered device 202. In another embodiment and as previously described, the triggered device 202 may optionally receive additional information from the cloud server or services 106 or supplemental information from an additional source 302. In one example, the additional source 302 may be the Internet, a memory storage of the triggered device, and other networked informational source.

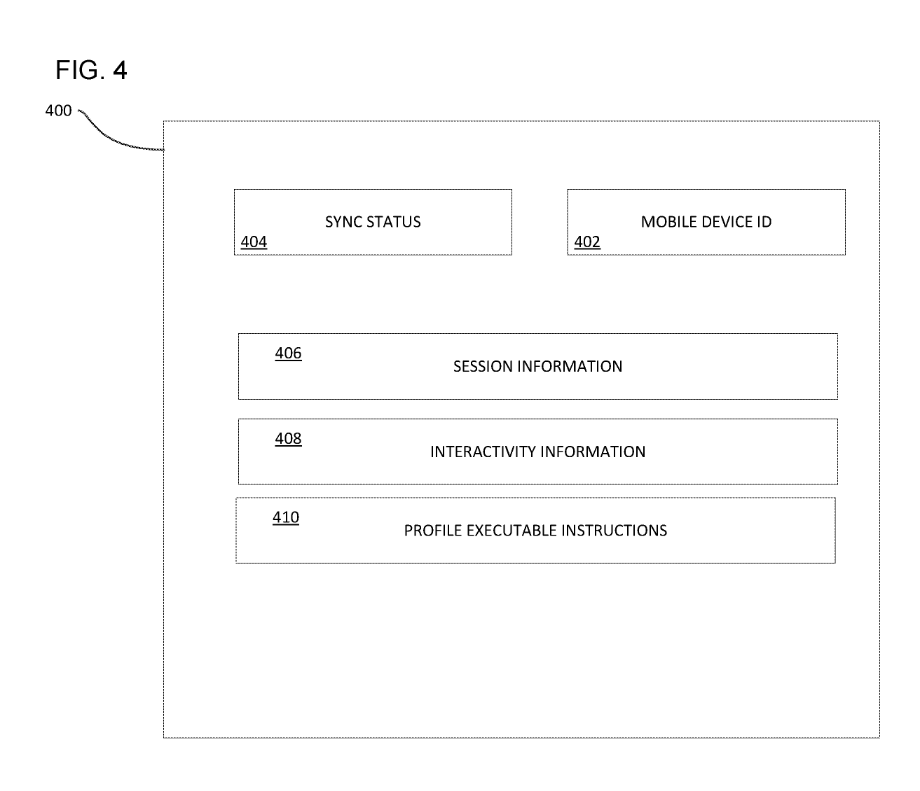

FIG. 4 may illustrate a diagram of exemplary data structure of a user profile according to one embodiment of the invention. In one example, a data structure 400 may include a data field 402 for storing mobile device identification. This data field 402 may be of formats that are known, such as alphanumerical format, text string format, etc., of 8-bit, 16-bit or any other unit. In one embodiment, the data field 402 may be hashed or encrypted. The data structure 400 may further include a data field for storing synchronization status of the user profile 114 or 108. In another embodiment, the data structure 400 may include a data field 406 for storing session information of the mobile device 112. In one example and not as a limitation, the session information may include time stamps, state of the mobile device 112 with information such as geographical data, battery data, browser state, app state, state information of the wireless devices of the mobile device 112. The data structure 400 may further include a data field 408 for storing interactivity information. In one example and not as a limitation, the interactivity information may include information about/from cookies, information about/from browsing histories, information about/from page cache, information about/from app cache, information about/from wireless devices of the mobile device 112, loyalty program information of the user, payment information of the user, and/or information about/from other parts of the mobile device 112. It is to be understood that the interactivity information may also include information about/from the mobile device 112 relating to the interactive activities that an manufacturer of the mobile device 112 may collect from the user 102 for various purposes, such as diagnostic or enhancement purposes. The data structure 400 further may include a data field 410 for storing profile executable instructions or codes. The profile executable instructions or codes may include a collection of computer executable instructions for processing information stored in the data structure 400, and computer executable instructions for operating or activating devices or parts of the mobile device 112. In another embodiment, the data field 410 may store the computer executable instructions to monitor or track triggering events. In another embodiment, the profile executable instructions may be pushed, updated, or provided by the cloud server or services 106 when the user profile 114 is synchronized with the user profile 108.

It is to be understood that the data fields 402 to 410 may include other properties. It is also to be understood that each of the data fields in the data structure 400 may be further segmented or divided into different units to meet the storage needs. In addition, the data structure 400 needs not limited to a single file. It may be compressed file or a cab file that may be uncompressed by the processor(s) at the mobile device 112, the cloud server or services 106, or the triggered device 202. In another embodiment, the data structure 400 may include additional data fields without departing from the scope or spirit of the invention. In another embodiment, the data structure 400 may include metadata and may present the information as metadata matrix using a structured format (e.g., XML), an unstructured format (e.g., TXT file), or a combination of the two.

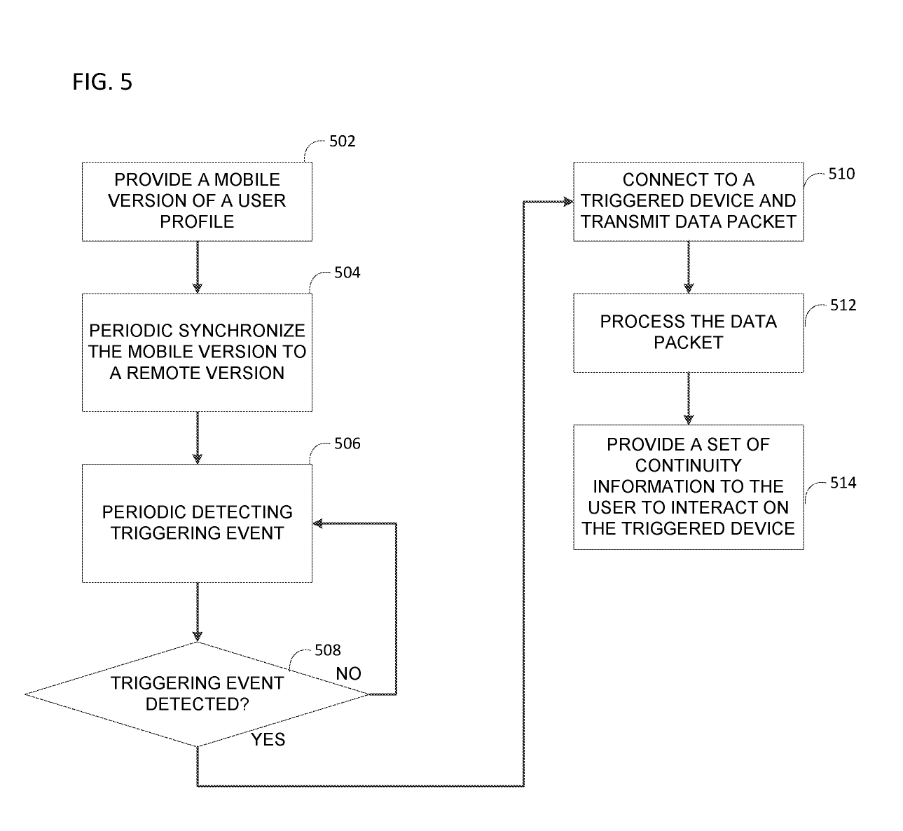

FIG. 5 may illustrate a flow chart of a computerized method of an intelligent mobile device triggered terminal according to one embodiment of the invention. At 502, the method may provide a mobile version of a user profile to be instantiated on a mobile device operable by the user. For example, the method may provide the mobile version in response to a user's request to establish an account. As previously described, a version of the user profile may be stored on the mobile device and another version of the profile may be stored on a remote data store. At 504, the method may periodically synchronize the mobile version to the remote version. In this example, the synchronization schedule may be predetermined or dynamic. In one embodiment, the method further may update the mobile version of the user profile in response to one or more triggering interactions. At 506, the method may periodically detect one or more triggering events. As discussed above, the triggering event may include the mobile device detecting a triggered device capable of receiving data packets from the mobile device.

At 508, it may be determined whether the triggering event has been detected. If the determination is positive, the method may proceed to 510 to connect to the triggered device and transmit a data packet to the triggered device. If the determination is negative, the method may return to 506. At 512, the triggered device, which may be caused by the profile executable instructions in the data packet, may process the data packet. At 514, the method may cause the triggered device to provide a set of continuity information to the user to interact on the triggered device.

In another embodiment, the computerized method described in connection with FIG. 5 may be provided or pushed by the cloud server or services 106. In such an embodiment, the cloud server or services 106 may be a transaction server capable of processing payment transactions or electronic commerce transactions. As such, the transaction server may push executable instructions to the user profile as part of payload for execution by the mobile device or the triggered device.

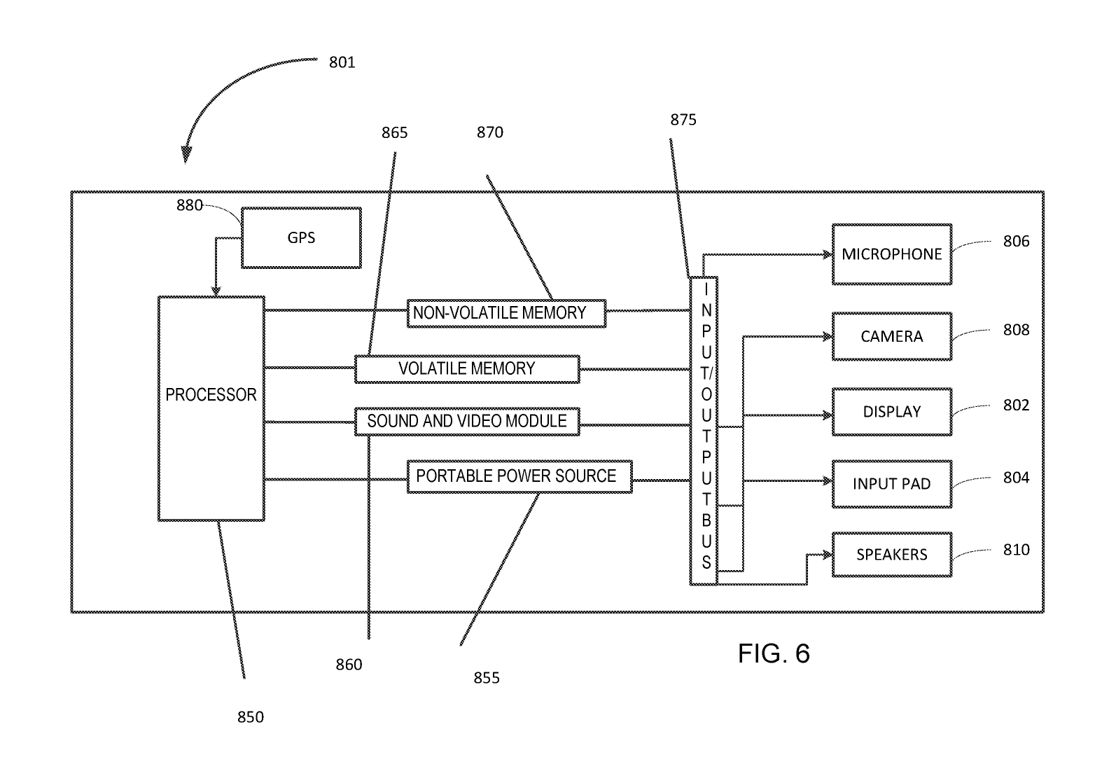

FIG. 6 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

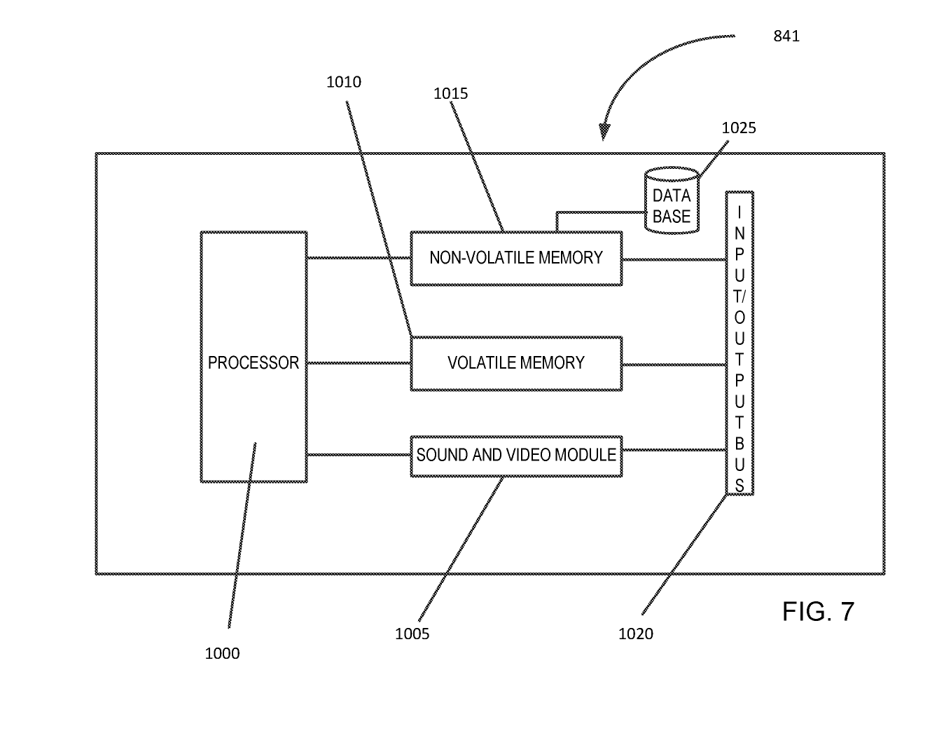

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The claimed system and method may address several technical problems and challenges, some of which are described. Currently, entering potential sensitive data across networks makes users nervous to the point that a sale may be lost or money or time saving tips or coupons may not be received. By using a proprietary network such as a payment network, to transfer potentially sensitive data, security may be higher and users may be more open to joining additional beneficial programs. Similarly, moving data from one payment system to another loyalty system has felt risky to some users, but by using a proprietary, trusted network, the data may be communicated in a more trustworthy fashion. In addition, formatting data and communicating data in a manner which may be understood by a variety of additional programs is a technical challenge or problem which the system and method has addressed.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving user transaction systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A system for provisioning communications between a mobile device and a triggered device comprising:
a transaction server remote with respect to the mobile device for establishing an account in response to a request from a user to create the account, said account comprising a user profile having a data structure with one or more data fields;
a data store remote with respect to the mobile device for storing the user profile, said data store being accessible by the transaction server and the mobile device via a communications network;
in response to authenticating the account by the user on the mobile device, the mobile device instantiates a version of the user profile on the mobile device;
wherein the mobile device comprises a processor configured to execute profile executable instructions associated with the instantiated user profile to identify at least one of the following triggering interactions of the user on the mobile device: user activities with the mobile device, online content, state of usages of the mobile device, and session information of the mobile device;
wherein the profile executable instructions define a data packet for the identified interactivity information for transmission in response to a triggering event;
a triggered device, in response to the received data packet, is configured to process the data packet; and
wherein the triggered device provides a set of continuity information as a function of the received data packet to the user via a user interface connected to the triggered device.

2. The system of claim 1, wherein the mobile device instantiates the version of the user profile in response to installing a program on the mobile device after authenticating the account.

3. The system of claim 1, wherein the data structure includes the one or more data fields for storing at least the following information: synchronization status, mobile device identification, session information, interactivity information, and profile executable instructions.

4. The system of claim 1, wherein the processor of the mobile device is configured to update the version of the user profile on the mobile device in response to one or more triggering interactions.

5. The system of claim 1, wherein the processor of the mobile device is configured to synchronize the version of the user profile on the mobile device with the user profile stored in the data store in response to a periodic frequency or a specific triggering interaction.

6. The system of claim 1, wherein the set of continuity information includes a set of recommendations based on information in the data packet.

7. The system of claim 1, wherein the triggered device is further configured to interact with the user to authenticate the user to operate the triggered device prior to providing the set of continuity information to the user.

8. A computerized method for providing continuity information from a mobile device to a triggered device comprising:
in response to receiving a request to establish an account from a mobile device operable by a user, providing a mobile version of a user profile to be instantiated on a mobile device operable by the user, said user profile having a data structure with one or more data fields;
periodically synchronizing the mobile version of the user profile on the mobile device with a remote version of the user profile stored on a data store remote with respect to the mobile device, said data store being accessible by the mobile device via a communications network;
in response to a triggering interaction between the user and the mobile device, updating the mobile version of the user profile with information of the triggering interaction;
periodically detecting a triggering event to occur between the mobile device and a triggered device;
in response to the detected triggering event, defining a data packet for transmission from the mobile device to the triggered device, said data packet including profile executable instructions for processing by the triggered device; and
transmitting the data packet to the triggered device, wherein the triggered device is configured to process the data packet and enabling a set of continuity information to be provided to the user via a user interface connected to the triggered device, said set of continuity information comprising information as a function of the received data packet.

9. The computerized method of claim 8, wherein the triggering interaction comprises at least one of the following: user activities with the mobile device, online content, state of usages of the mobile device, and session information of the mobile device;

10. The computerized method of claim 8, wherein providing the mobile version of the user profile to be instantiated on the mobile device comprises providing the mobile version of the user profile to be instantiated on the mobile device in response to installing a program on the mobile device after authenticating the account.

11. The computerized method of claim 8, wherein the data structure includes the one or more data fields for storing at least the following information: synchronization status, mobile device identification, session information, interactivity information, and profile executable instructions.

12. The computerized method of claim 8, wherein the set of continuity information includes a set of recommendations based on information in the data packet.

13. The computerized method of claim 8, further comprising providing the set of continuity information to the user in response to authenticating the user to operate the triggered device.

14. A computerized method for providing continuity information from a mobile device to a triggered device comprising:
in response to receiving a request, by a transaction server, establishing an account storing a remote version of a user profile on a data store, said data store accessible by the transaction server via a communications network;
in response to an event on a mobile device, providing a mobile version of the user profile to be instantiated on the mobile device operable by a user, said mobile device being remote with respect to the transaction server or the data store;
periodically synchronizing the mobile version of the user profile on the mobile device with the remote version of the user profile stored on the data store remote with respect to the mobile device;
providing, by the transaction server, profile executable instructions to the mobile version of the user profile to the mobile device for execution to detect a triggering interaction between the user and the mobile device, said profile executable instructions comprising a collection of computer executable instructions for execution by the mobile device or a triggered device;
in response to detecting the triggering interaction, updating the mobile version of the user profile with information of the triggering interaction;
providing, by the transaction server, the profile executable instructions to the mobile version of the user profile to the mobile device for execution to periodically detect a triggering event to occur between the mobile device and the triggered device;
in response to the detected triggering event on the mobile device, defining a data packet for transmission from the mobile device to the triggered device; and
transmitting, by the transaction server, the profile executable instructions to the triggered device for processing the data packet at the triggered device for providing a set of continuity information to be provided to the user via a user interface connected to the triggered device, said set of continuity information comprising information as a function of the received data packet.

15. The computerized method of claim 14, wherein the triggering interaction comprises at least one of the following: user activities with the mobile device, online content, state of usages of the mobile device, and session information of the mobile device;

16. The computerized method of claim 14, wherein providing the mobile version of the user profile to be instantiated on the mobile device comprises providing the mobile version of the user profile to be instantiated on the mobile device in response to installing a program on the mobile device after authenticating the account.

17. The computerized method of claim 14, wherein the data structure includes the one or more data fields for storing at least the following information: synchronization status, mobile device identification, session information, interactivity information, and profile executable instructions.

18. The computerized method of claim 14, wherein the set of continuity information includes a set of recommendations based on information in the data packet.

19. The computerized method of claim 14, further comprising providing the set of continuity information to the user in response to authenticating the user to operate the triggered device.

20. The computerized method of claim 14, further comprising providing the set of continuity information to the user in response to receiving supplemental information source as a function of the data packet.
